(19) United States
(12) Patent Application Publication
(10) Pub. No.: US 2013/0110913 A1
(43) Pub. Date: May 2, 2013

(54) APPARATUS AND METHOD FOR PROVIDING DISTRIBUTED CLOUD SERVICE

(71) Applicant: Electronics and Telecommunications Research Institute, Daejeon (KR)

(72) Inventors: Hwanjo HEO, Daejeon (KR); Jong Dae PARK, Daejeon (KR); Tae-Soo CHUNG, Daejeon (KR); Byung Ho YAE, Daejeon (KR); Sung Jin MOON, Daejeon (KR); Woo-Sug JUNG, Daejeon (KR); Sung Kee NOH, Daejeon (KR); Nam Seok KO, Daejeon (KR)

(73) Assignee: Electronics and Telecommunications Research Institute, Daejeon (KR)

(21) Appl. No.: 13/666,574

(22) Filed: Nov. 1, 2012

(30) Foreign Application Priority Data
Nov. 1, 2011 (KR) 10-2011-0113019
Sep. 17, 2012 (KR) 10-2012-0103040

(51) Int. Cl. G06F 15/16

(52) U.S. Cl. 709/203

(57) ABSTRACT

A distributed cloud service providing apparatus of a client terminal converts first information to store to a plurality of second information parts, stores the plurality of second information parts at a plurality of cloud servers, respectively, obtains the first information using the second information parts that are received from at least some cloud servers of the plurality of cloud servers according to a user request, and provides the first information to the user.

### CROSS-REFERENCE TO RELATED APPLICATION

This application claims priority to and the benefit of Korean Patent Application No. 10-2011-0113019 and 10-2012-0103040 filed in the Korean Intellectual Property Office on Nov. 1, 2011 and Sep. 17, 2012, the entire contents of which are incorporated herein by reference.

### BACKGROUND OF THE INVENTION

(a) Field of the Invention

The present invention relates to a method and apparatus for providing a distributed cloud service.

(b) Description of the Related Art

Cloud computing indicates an environment that transfers computing (computing resource, software, or information) as a service through a network.

Nowadays, in an industrial field, providers provide a cloud computing environment as a service and thus it is usual for corporations or individuals to purchase and use a computing resource in a service form from a cloud computing provider instead of purchasing a computing resource as a product. Therefore, corporations or individuals obtain or store information by approaching an infrastructure of a contracted specific cloud computing provider using a user terminal, which is a client, through a network. Such a service is called a “single cloud service”.

The single cloud service is simple and is performed through a contract between one cloud provider and a corporation (or individual) and is thus convenient, but has the following problems. First, the single cloud service is weak in security. An invader may invade a single cloud or may eavesdrop on communication between a single cloud and a client. Further, a cloud provider may obtain a profit by intentionally leaking information of a corporation or an individual for which the cloud provider provides a service. Therefore, a corporation or an individual that uses a cloud service should be able to trust a cloud provider. Second, the single cloud service has low availability. When an infrastructure in which a cloud provider operates is in a state that cannot provide a service because of a power failure, a disaster, or an invasion, corporations or individuals cannot receive the service.

As a method of overcoming the above problems, a method of receiving a service from a plurality of cloud servers exists. This is called a “distributed cloud computing service”. For such a distributed cloud computing service, a definition of a method of distributing, storing, and collecting information at a plurality of cloud servers is necessary.

### SUMMARY OF THE INVENTION

The present invention has been made in an effort to provide a method and apparatus for providing a distributed cloud service having advantages of solving a problem of security vulnerability and low availability of a single cloud service.

An exemplary embodiment of the present invention provides a method in which a client terminal provides a distributed cloud service to a user. The method includes: storing a plurality of second information parts representing first information at a plurality of cloud servers, respectively; requesting the first information from the plurality of cloud servers; and obtaining the first information using the second information parts that are received from at least some cloud servers of the plurality of cloud servers and providing the first information to a user.

The method may further include setting a threshold value, wherein the first information may be obtained when the second information is received from a cloud server of the threshold value or more among the plurality of cloud servers.

The storing of a plurality of second information parts may include converting the first information to the plurality of second information parts using a threshold cryptosystem.

The requesting of the first information may include transmitting a plurality of third information parts representing request information of the first information to the plurality of cloud servers, respectively.

The storing of a plurality of second information parts may include forming the plurality of third information parts and the plurality of second information parts to correspond to each other and transmitting the information to the plurality of cloud servers, respectively.

The transmitting of a plurality of third information parts may include converting the request information to the plurality of third information parts using a threshold cryptosystem.

The method may further include testing integrity of the obtained first information.

The testing of integrity may include obtaining first information from second information that is received from a cloud server that is formed with a different combination from that of the at least some cloud servers; and testing the integrity through comparison of the two first information parts.

Another embodiment of the present invention provides a distributed cloud service providing apparatus of a client terminal. The distributed cloud service providing apparatus includes: a controller that converts first information to a plurality of second information parts and that stores the plurality of second information parts at a plurality of cloud servers, respectively, and that obtains the first information using second information parts that is received from at least some cloud servers of the plurality of cloud servers according to a user request; and a providing unit that provides the first information to the user.

The controller may test integrity of the first information using second information parts that is received from at least some cloud servers of a different combination from that of the at least some cloud servers.

The controller may convert the request to a plurality of third information parts and transmit the plurality of third information parts to the plurality of cloud servers, respectively.

The controller may set a threshold value, and the first information may be obtained, when the second information parts are received from a cloud server of the threshold value or more of the plurality of cloud servers.

### BRIEF DESCRIPTION OF THE DRAWINGS

FIG. 1 is a diagram illustrating a cloud computing system according to an exemplary embodiment of the present invention.

FIG. 2 is a flowchart illustrating an example of a method in which a client terminal stores information at a cloud server according to an exemplary embodiment of the present invention.

FIG. 3 is a flowchart illustrating a method in which a client terminal receives information from a cloud server according to an exemplary embodiment of the present invention.

FIG. 4 is a flowchart illustrating another example of a method in which a client terminal stores information at a cloud server according to an exemplary embodiment of the present invention.

FIG. 5 is a flowchart illustrating another example of a method in which a client terminal receives information from a cloud server according to an exemplary embodiment of the present invention.

FIG. 6 is a diagram illustrating an example of an information request and response in a distributed threshold cloud service according to an exemplary embodiment of the present invention.

FIG. 7 is a block diagram illustrating a configuration of a distributed threshold cloud service providing apparatus of a client terminal according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a system and method for providing a distributed cloud computing service according to an exemplary embodiment of the present invention will be described in detail with reference to the drawings.

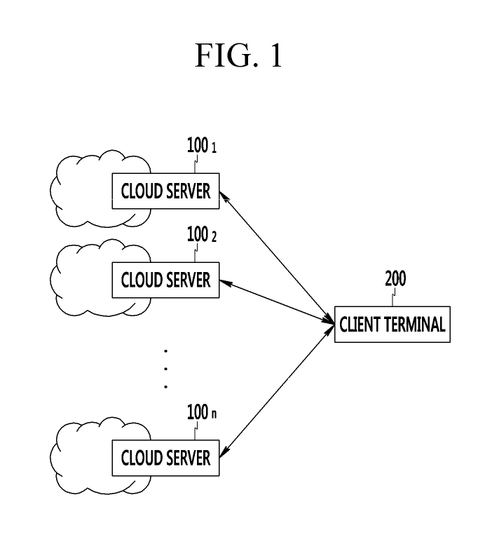

FIG. 1 is a diagram illustrating a cloud computing system according to an exemplary embodiment of the present invention.

Referring to FIG. 1, the cloud computing system includes a plurality of cloud servers 100₁-100ₙ that provide a distributed threshold cloud service and a client terminal that receives a distributed threshold cloud service from the plurality of cloud servers 100₁-100ₙ.

The distributed threshold cloud service is a kind of distributed cloud service for solving a problem of security vulnerability and low availability of a single cloud service.

The distributed threshold cloud service is a service method in which a client terminal 200 distributes and stores information at the plurality of cloud servers 100₁-100ₙ and receives information by collecting information that it receives from the cloud servers 100₁-100ₙ of a threshold value or more.

In order to distribute, store, and collect information, the client terminal 200 uses a threshold cryptosystem. Further, the client terminal 200 tests integrity of the collected information.

The cloud servers 100₁-100ₙ each store information that receives from the client terminal 200 and provide corresponding information to the client terminal 200 according to an information request of the client terminal 200. The cloud servers 100₁-100ₙ may be provided by different providers, may be geographically located at different locations, and may be formed with different hardware/software. Here, the cloud servers 100₁-100ₙ may be a cloud computing infrastructure.

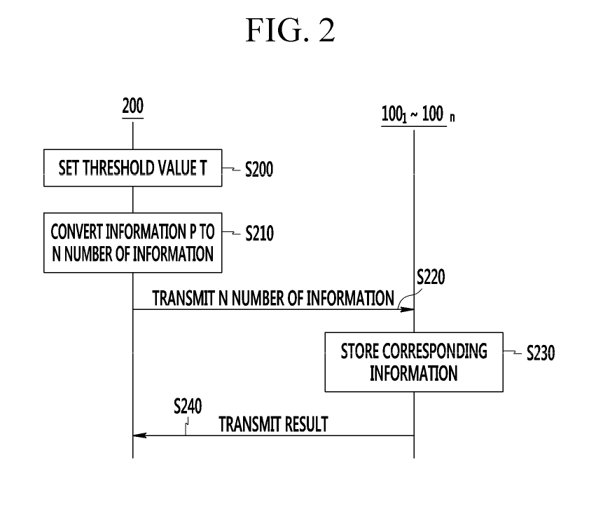

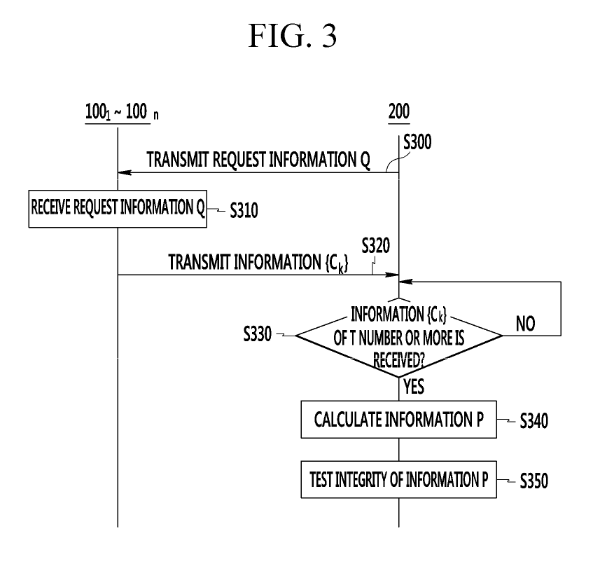

Hereinafter, in order to provide a distributed threshold cloud service, a method in which a client terminal stores information at a cloud server will be described with reference to FIGS. 2 and 3.

Before starting a description, information that the client terminal 200 has is referred to as P. The information P may be information to be stored at distributed of cloud servers 100₁-100ₙ, may be information that is brought and collected from the plurality of cloud servers 100₁-100ₙ, and may be a query that is transferred to the plurality of cloud servers 100₁-100ₙ.

FIG. 2 is a flowchart illustrating an example of a method in which a client terminal stores information at a cloud server according to an exemplary embodiment of the present invention.

Referring to FIG. 2, the client terminal 200 sets a threshold value t according to requirements (S200).

The client terminal 200 converts information P to the n number of information parts using a threshold cryptosystem (S210).

The client terminal 200 transmits the n number of information parts to n number of cloud servers 100₁-100ₙ, respectively (S220).

The cloud servers 100₁-100ₙ each store the received information (S230) and transmit a result thereof to the client terminal 200 (S240). Information that is stored at each of the cloud servers 100₁-100ₙ is referred to as Cₖ (0≦k<n). Therefore, {Cₖ} and P have an (n,t)-threshold property using the threshold cryptosystem. Therefore, when stored information {Cₖ} of the t number or more is provided according to an (n,t)-threshold property, P may be stably obtained, and when stored information {Cₖ} of less than the t number is provided, it is difficult to analogize the information P. In this case, a degree of difficulty may be influenced by a threshold cryptosystem used.

In this way, in order to receive the information P, even if cloud servers of the (n-t) number or less are unavailable, the client terminal 200 obtains original information P using stored information {Cₖ} that is brought from the t number of available cloud servers.

However, when storing the information P at the cloud servers 100₁-100ₙ, all cloud servers 100₁-100ₙ are not available and thus when {Cₖ} is stored at cloud servers of less than the n number, if information is called later from the cloud server to the client terminal, the information P cannot satisfy an (n,t)-threshold property. Therefore, the client terminal 200 updates and transmits {Cₖ} that could not be transferred because the cloud server was not available when a corresponding client server is available later, and thus the n number of cloud servers 100₁-100ₙ may have Cₖ for the information P.

FIG. 3 is a flowchart illustrating a method in which a client terminal receives information from a cloud server according to an exemplary embodiment of the present invention.

Referring to FIG. 3, in order to receive information P, the client terminal 200 transmits request information Q to the cloud servers 100₁-100ₙ (S300). In this case, the request information Q may be a file name or may be a query for search.

When the cloud servers 100₁-100ₙ receive the request information Q (S310), the cloud servers 100₁-100ₙ transmit the stored information {Cₖ} to the client terminal 200 (S320).

The client terminal 200 determines whether information {Cₖ} of the t number or more is received (S330), and if information {Cₖ} of the t number or more is received, the client terminal 200 calculates the information P using the information {Cₖ} of the t number or more (S340).

If {Cₖ} of less than the t number is received, it is difficult for the client terminal 200 to analogize P, and thus until stored information {Cₖ} of the t number or more is received, the client terminal 200 stands by.

The client terminal 200 obtains the information P and tests integrity of the obtained information P (S350). That is, if {Cₖ} of the (t+1) number or more is provided, the client terminal 200 tests integrity of the information using the {Cₖ}. Because a threshold cryptosystem can obtain P with any combination of the t number among the total n number of {Cₖ}, when the t number of {Cₖ} that is received from at least two groups of cloud servers of different combinations are provided, the client terminal 200 obtains P using the t number of {Cₖ}, having been received from a cloud server of each group and tests integrity through comparison of the Ps. When Ps that are obtained using the t number of {Cₖ} having been received from a cloud server of each group are the same, the client terminal 200 determines that information P is the same as original information.

In a case of FIG. 3, in order to receive information P, the client terminal 200 transmits request information Q to the cloud servers 100₁-100ₙ, and the request information Q is transferred to each of the cloud servers 100₁-100ₙ. Because the request information Q is transferred to each of the cloud servers 100₁-100ₙ, the request information Q may be eavesdropped or a cloud provider may obtain useful information from the request information without permission.

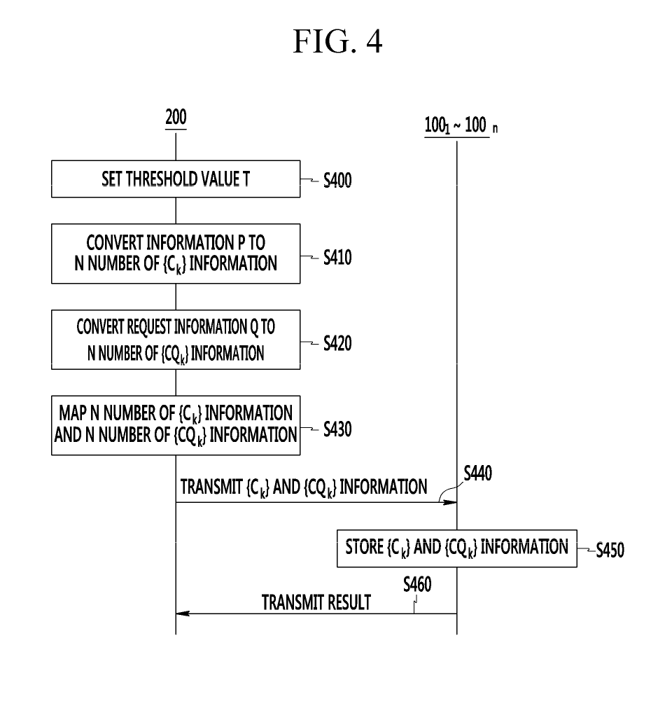

FIG. 4 is a flowchart illustrating another example of a method in which a client terminal stores information at a cloud server according to an exemplary embodiment of the present invention.

Referring to FIG. 4, the client terminal 200 sets a threshold value t according to requirements (S400).

The client terminal 200 converts information P to the n number of {Cₖ} information using a threshold cryptosystem (S410). The client terminal 200 converts request information Q to the n number of {CQₖ} information using the threshold cryptosystem (S420).

The client terminal 200 maps the n number of {Cₖ} information and the n number of {CQₖ} information one-to-one (S430), and transmits the n number of corresponding {Cₖ} and {CQₖ} information to the n number of cloud servers 100₁-100ₙ, respectively (S440).

The cloud servers 100₁-100ₙ each store the received {Cₖ} and {CQₖ} information (S450) and transmit a result thereof to the client terminal 200 (S460).

In such a case, because the request information Q has an (n,t)-threshold property, in order to find out the request information Q, {Cₖ} of the t number or more is necessary and thus a cloud provider cannot obtain useful information P without permission from the request information Q.

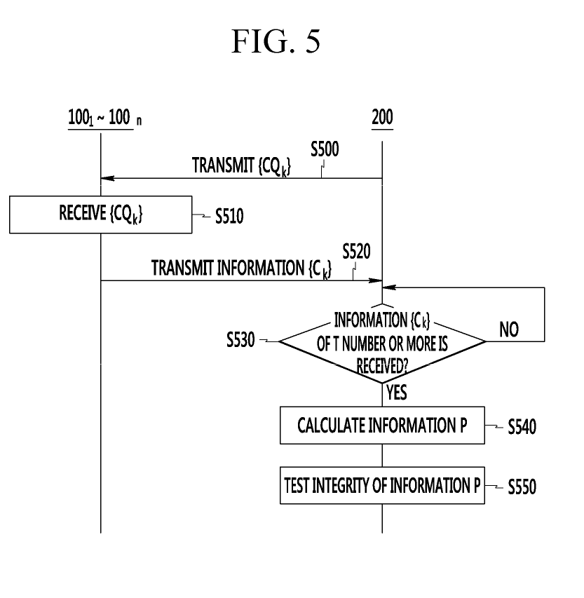

FIG. 5 is a flowchart illustrating another example of a method in which a client terminal receives information from a cloud server according to an exemplary embodiment of the present invention.

Referring to FIG. 5, in order for the client terminal 200 to receive information P, the client terminal 200 transmits the n number of {CQₖ} to the cloud servers 100₁-100ₙ, respectively (S500).

When the cloud servers 100₁-100ₙ receive corresponding {CQₖ}(S510), the cloud servers 100₁-100ₙ transmit information {Cₖ} that has been stored to correspond to the received {CQₖ} to the client terminal 200 (S520).

The client terminal 200 determines whether information {Cₖ} of the t number or more is received (S530), and if information {Cₖ} of the t number or more is received, the client terminal 200 calculates information P using the information {Cₖ} of the t number or more (S540).

The client terminal 200 tests integrity of the information P with the same method as a method that is described with reference to FIG. 3 (S550).

A distributed threshold cloud service has the following merits by such an (n,t)-threshold property.

First, the distributed threshold cloud service is safe. Only when an invader invades cloud servers of the t number or more independent of stability of each of the cloud servers 100₁-100ₙ can the invader obtain original information. As described above, because the t number of cloud servers 100₁-100ₙ may be formed with different hardware/software, the invader should provide different invasion routes to each of the n number of cloud servers 100₁-100ₙ and thus many efforts are necessary for invasion. Similarly, only when bugging communication between client terminal 100 and cloud servers of the t number or more can original information be found. Further, even if a cloud provider intentionally accesses information, even when providers of the t number or more conspire, original information cannot be found and thus the cloud provider can safely use a cloud service without trusting an individual cloud provider.

Second, the distributed threshold cloud service has high availability. When stored information {Cₖ} of the t number or more exists, original information can be obtained, and thus even if the (n-t) number of cloud servers do not operate, a cloud user can use a cloud service. As described above, because the n number of cloud servers 100₁-100ₙ may be operated by different providers, a service failure of each of the cloud servers 100₁-100ₙ due to an operation mistake may become an independent variable. Because each of the cloud servers 100₁-100ₙ may be located at different geographical locations, a power failure or a disaster may not simultaneously occur. Further, because the cloud servers 100₁-100ₙ may be formed with different hardware/software, a service failure by invasion may independently occur. Various independent properties between such cloud servers 100₁-100ₙ cause a probability of elements simultaneously obstructing availability occur at cloud servers of the t number or more to be maintained as low.

Further, when {Cₖ} of the (t+1) number or more is provided, integrity of information may be tested using the {Cₖ}.

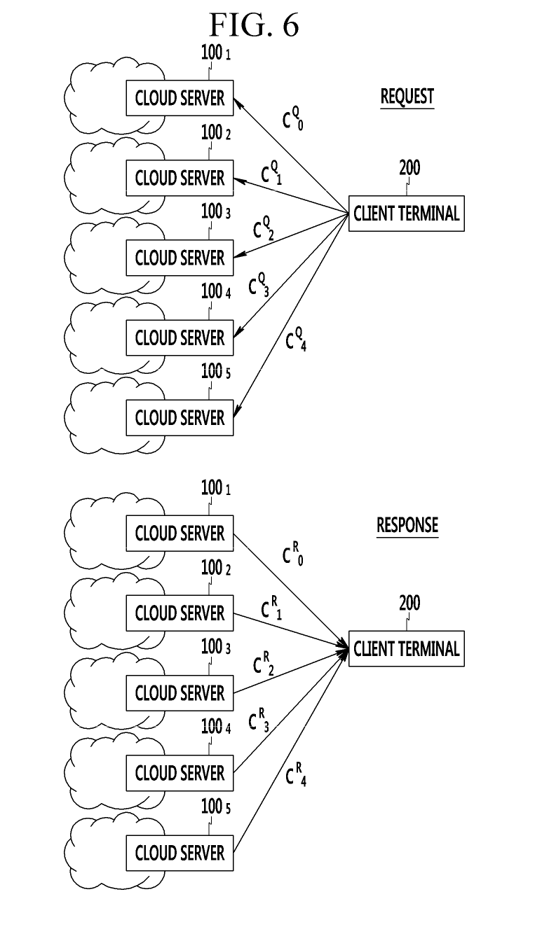

FIG. 6 is a diagram illustrating an example of an information request and response in a distributed threshold cloud service according to an exemplary embodiment of the present invention. In FIG. 6, for convenience of description, five cloud servers are illustrated.

Referring to FIG. 6, the client terminal 200 converts an information request P^{Q} to five information {C^{Q}₀, C^{Q}₁, C^{Q}₂, C^{Q}₃, C^{Q}₄} parts using a threshold cryptosystem and transfers the five information {C^{Q}₀, C^{Q}₁, C^{Q}₂, C^{Q}₃, C^{Q}₄} parts to the cloud servers 100₁-100₅.

A k-th (0≦k<5) cloud server 100ₖ transfers response information C^{Q}ₖ that is generated and stored by the threshold cryptosystem from C^{Q}ₖ to the client terminal 200.

The client terminal 200 obtains response information P^{R} using {C^{R}ₖ} that is received from the cloud servers 100₁-100₅. In this case, even if the t number of {C^{R}ₖ} exist according to the t number of a distributed threshold cloud service that is defined by an (n,t)-threshold property, the client terminal 200 obtains P^{R}. That is, when the number of presently available cloud servers is a, if a≧t, P^{R} may be obtained, and if a>t, P^{R} may be obtained with the ₙCₐ number of different combinations, and thus integrity can be tested.

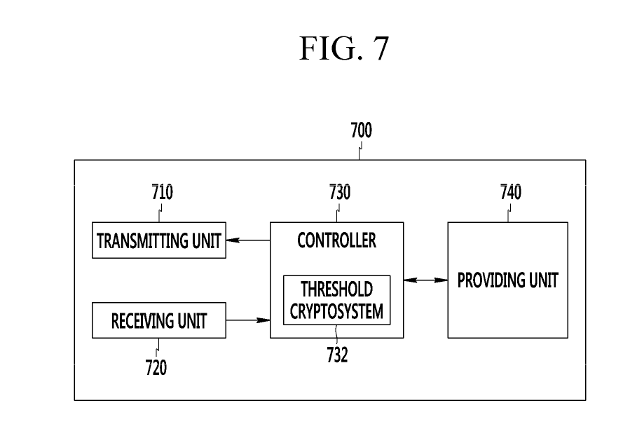

FIG. 7 is a block diagram illustrating a configuration of a distributed threshold cloud service providing apparatus of a client terminal according to an exemplary embodiment of the present invention.

Referring to FIG. 7, a distributed threshold cloud service providing apparatus 700 is embodied in the client terminal 200, and in order to provide a distributed threshold cloud service to a cloud user, the distributed threshold cloud service providing apparatus 700 includes a transmitting unit 710, a receiving unit 720, a controller 730, and a providing unit 740.

The controller 730 includes a threshold cryptosystem 732. The threshold cryptosystem 732 sets a threshold value t and converts information P to the n number of {Cₖ} information. The threshold cryptosystem 732 may convert request information Q to the n number of {CQₖ} information. Further, when the threshold cryptosystem 732 receives {Cₖ} information from cloud servers of the t number or more among the n number of cloud servers 100₁-100ₙ, the threshold cryptosystem 732 obtains information P using the t number of received {Cₖ} information.

In this case, when the controller 730 receives {Cₖ} information from cloud servers of the (t+1) number or more, the controller 730 obtains information P using the t number of {Cₖ} information that is formed with different combinations, compares two obtained information P, and tests integrity of the information P.

The transmitting unit 710 transmits {Cₖ} information and/or {CQₖ} information to a corresponding cloud server according to the control of the controller 730.

The receiving unit 720 receives the {Cₖ} information from the cloud server 100ₖ.

The providing unit 740 provides information P that is obtained using the t number of {Cₖ} information parts to a cloud user.

According to an exemplary embodiment of the present invention, a distributed cloud computing service having safety and high availability can be provided. Further, the distributed cloud computing service can test integrity of information.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a client terminal provides a distributed cloud service to a user, the method comprising:
storing a plurality of second information parts representing first information at a plurality of cloud servers, respectively;
requesting the first information from the plurality of cloud servers; and
obtaining the first information using the second information parts that are received from at least some cloud servers of the plurality of cloud servers and providing the first information to a user.

2. The method of claim 1, further comprising setting a threshold value,
wherein the first information is obtained when the second information is received from a cloud server of the threshold value or more among the plurality of cloud servers.

3. The method of claim 1, wherein the storing of a plurality of second information parts comprises converting the first information to the plurality of second information parts using a threshold cryptosystem.

4. The method of claim 1, wherein the requesting of the first information comprises transmitting a plurality of third information parts representing request information of the first information to the plurality of cloud servers, respectively.

5. The method of claim 4, wherein the storing of a plurality of second information parts comprises forming the plurality of third information parts and the plurality of second information parts to correspond to each other and transmitting the information to the plurality of cloud servers, respectively.

6. The method of claim 4, wherein the transmitting of a plurality of third information parts comprises converting the request information to the plurality of third information parts using a threshold cryptosystem.

7. The method of claim 1, further comprising testing integrity of the obtained first information.

8. The method of claim 7, wherein the testing of integrity comprises:
obtaining first information from second information that is received from a cloud server that is formed with a different combination from that of the at least some cloud servers; and
testing the integrity through comparison of the two first information parts .

9. A distributed cloud service providing apparatus of a client terminal, the distributed cloud service providing apparatus comprising:
a controller that converts first information to a plurality of second information parts and that stores the plurality of second information parts at a plurality of cloud servers, respectively, and that obtains the first information using second information parts that is received from at least some cloud servers of the plurality of cloud servers according to a user request; and
a providing unit that provides the first information to the user.

10. The distributed cloud service providing apparatus of claim 9, wherein the controller tests integrity of the first information using second information parts that is received from at least some cloud servers of a different combination from that of the at least some cloud servers.

11. The distributed cloud service providing apparatus of claim 9, wherein the controller converts the request to a plurality of third information and transmits the plurality of third information to the plurality of cloud servers, respectively.

12. The distributed cloud service providing apparatus of claim 9, further comprising:
a transmitting unit that transmits the plurality of second information parts to the plurality of cloud servers, respectively; and
a receiving unit that receives second information parts from at least some cloud servers.

13. The distributed cloud service providing apparatus of claim 9, wherein the controller sets a threshold value, and
the first information is obtained when the second information parts are received from a cloud server of the threshold value or more of the plurality of cloud servers.
